(19) United States
(12) Patent Application Publication
(10) Pub. No.: US 2021/0288752 A1
(43) Pub. Date: Sep. 16, 2021

(54) MODULATION AND BINARY CONVOLUTIONAL CODING FOR MULTIPLE RESOURCE UNITS IN WIRELESS NETWORK

(71) Applicants: Jung Hoon SUH, Ottawa (CA); Yan XIN, Ottawa (CA); Osama ABOUL-MAGD, Ottawa (CA)

(72) Inventors: Jung Hoon SUH, Ottawa (CA); Yan XIN, Ottawa (CA); Osama ABOUL-MAGD, Ottawa (CA)

(21) Appl. No.: 17/200,061

(22) Filed: Mar. 12, 2021

Related U.S. Application Data
(60) Provisional application No. 62/989,573, filed on Mar. 13, 2020.

(51) Int. Cl. H04L 1/00; H04L 5/00

(52) U.S. Cl. CPC H04L 1/0059; H04L 5/0007; H04L 1/0003; H04L 1/0009; H04L 1/0058

(57) ABSTRACT

Methods and devices, such as transmitters, for transmitting data in an Orthogonal Frequency-Division Multiple Access (OFDMA) wireless local area network. The transmitter, comprising: a binary convolutional coding (BCC) encoder configured to perform BCC encoding on a sequence of data bits and to generate a sequence of coded bits that will be transmitted on multiple resource units (RUs) assigned to a STA; and an interleaver configured to perform an interleaving on the sequence of coded bits by using a matrix and generate an interleaved sequence, a number of the rows of the matrix and a number of the column of the matrix being determined based on respective modulation types indicated by respective MCSs selected for the multiple RUs.

### RELATED APPLICATIONS

The present application claims the benefit of and priority to U.S. Patent Application No. 62/989,573 filed Mar. 13, 2020, entitled “MODULATION AND BINARY CONVOLUTIONAL CODING FOR MULTIPLE RESOURCE UNITS IN WIRELESS NETWORK”, the contents of which are incorporated herein by reference.

### TECHNICAL FIELD

The present application relates to mobile air interface technologies, in particular to methods and systems for modulating and binary convolutional coding data for transmission in a wireless network.

### BACKGROUND

Networks that operate according to Wi-Fi protocols, including IEEE 802.11 protocols such as the IEEE 802.11ax specified in IEEE Draft P802.11ax_D6.0, use defined modulation and coding schemes (MCSs) that specify properties used for physical layer modulation and encoding.

A new protocol, IEEE 802.11be, is currently under development by IEEE 802.11 Task Group TGbe, and will be the next major IEEE 802.11 amendment to define the next generation of Wi-Fi after IEEE 802.11ax (currently IEEE Draft P802.11ax_D8.0). IEEE 802.11be (also called Extremely High Throughput (EHT)) is expected to support a data rate of at least 30 Gbps and may use a spectrum bandwidth up to 320 MHz for unlicensed operations, double the 160 MHz maximum bandwidth currently contemplated by IEEE 802.11ax.

IEEE 802.11ax supports Orthogonal Frequency-Division Multiple Access (OFDMA) transmission, in which data intended for different stations can be multiplexed within an OFDM symbol through the allocation of different subsets of subcarriers (tones). In IEEE 802.11ax, a Resource Unit (RU) consists of a group of contiguous subcarriers defined in the frequency domain. Different RUs can be assigned to different stations within a PPDU. Each RU is used for one OFDM symbol for one station (also referred to as a station (STA)). FIG. 1 illustrates an example of station (STA) resource allocation in IEEE 802.11ax. In the allocated RU, the MCS for each station is same across all the OFDM symbols (i.e., a single MCS is used for each station) within one PPDU. The MCSs used for RUs for different stations can be different within one PPDU.

In IEEE 802.11ax, RUs are defined based on RU sizes such as 26-tone RU, 52-tone RU, 106-tone RU, 242-tone RU, 484-tone RU, 996-tone RU and 2×996-tone RU. Information about multi-RUs assigned to a station, such as for each RU, the RU location and RU size, and the modulation and coding scheme (MCS) for the data transmitted over the assigned multi-RU, are indicated in the HE-SIG-B field of the physical layer (PHY) protocol data unit (PPDU) in IEEE 802.11ax. MCS information is provided in the form of an MCS index that specifies a set of physical layer properties including modulation and forward error correction (FEC) coding rate R. Two types of FEC coding available in IEEE 802.11ax are binary convolutional coding (BCC) and or low-density parity check (LDPC) coding. By way of illustrative example, FIG. 2 illustrates an example of MCS indexes that each correspond to a modulation type and a coding rate.

Under IEEE 802.11ax, the MCS used for an RU is determined based on channel conditions for the data transmission. In particular, the channel conditions are measured and averaged over all resources assigned for a station, and the average result used to select an appropriate MCS.

As indicated above, IEEE 802.11be will support a wide bandwidth, up to 320 MHz. The larger bandwidth introduces opportunities and issues that are not present in a narrower bandwidth system. In this regard, an operating feature called multiple RUs (multi-RU) has been proposed for IEEE 802.11be, in which multiple RUs that each have a respective sub-set of contiguous subcarriers can be allocated for one station in an OFDM symbol. However, existing proposals for multi-RU do not account for variations in link or channel conditions that may occur across the respective subcarrier groups allocated to the multiple RUs assigned to a particular station. Thus, optimizing performance (e.g., channel gain, goodput, signal-to-noise ratio (SNR), signal-to-interference-plus-noise ratio (SINR)) within the different RU channels pose a challenge especially for RUs having frequency resources that are separated far apart in frequency domain.

Accordingly, it is desirable to provide a system that can optimize channel efficiency and alleviate interference between subcarriers in multi-RU applications.

### SUMMARY

The present disclosure provides methods and systems for transmitting data in an Orthogonal Frequency-Division Multiple Access (OFDMA) wireless local area network. In particular, in the case where BCC encoding is applied in a transmitter, different configurations of the transmitter are disclosed herein for multi-RUs that are assigned to a single STA. However, the solutions described in this application are not limited to BCC, but applicable to any FEC scheme.

According to a first aspect of the disclosure a method is disclosed for processing data for transmission in an Orthogonal Frequency-Division Multiple Access (OFDMA) wireless network. According to the first aspect, the method includes encoding an input data stream of source data bits using a first coding rate to generate a data stream of multiple sets of coded bits for a target station that has been assigned multiple resource units, each set of coded bits corresponding to a respective one of the resource units; puncturing each of the multiple sets of coded bits in the data stream using a respective puncturing pattern to generate respective punctured coded data bits sequences that each correspond to a respective coding rate, wherein at least some of the respective puncturing patterns are different; and modulating each of the punctured coded data bits sequences using respective modulation types to generate respective modulated code sequences that are each mapped to a respective set of subcarriers that correspond to a respective resource unit of the multiple resource units.

In some examples of the first aspect, the method includes selecting the respective coding rates and the respective modulation types based on a channel conditions in the wireless network for the respective sets of subcarriers that correspond to the multiple resource units, enabling different coding rates and modulation types to be applied to the sets of coded bits that correspond to different resource units.

In one or more of the preceding examples of the first aspect, the respective coding rates and respective modulation types are specified by predefined modulation and coding schemes (MDCSss), wherein a different MCS is used for one of the sets of coded bits corresponding to a respective resource unit than for one or more other sets of the coded bits.

In one or more of the preceding examples of the first aspect, the respective sets of subcarriers are non-contiguous with each other.

In one or more of the preceding examples of the first aspect, each set of subcarriers that corresponds to a respective resource unit comprises up to a total of 242 contiguous subcarriers.

In one or more of the preceding examples of the first aspect, the at least one of the sets of subcarriers includes a different number of subcarriers than one or more other sets of the subcarriers.

In one or more of the preceding examples of the first aspect, the sets of subcarriers all fall within a 20 MHz channel.

In one or more of the preceding examples of the first aspect, encoding the input data stream comprises, for each set of coded bits, applying rate ½ binary convolution coding by applying a first generator polynomial and a second generator polynomial to a respective sequence of bits in the input data stream the generate the set of coded bits; and the method further comprises: parsing a stream that includes the punctured coded data bits sequences into separate streams that each include a respective one of the punctured coded data bits sequences that are each provided to a respective modulation operation for the modulating; and transmitting, in the wireless network, an orthogonal frequency division multiplexing (OFDM) symbol including the modulated code sequences.

According to a second aspect of the disclosure a method is disclosed for processing data for transmission in an Orthogonal Frequency-Division Multiple Access (OFDMA) wireless network. According to the second aspect, the method includes parsing an input data stream to generate multiple sequences of source data bits for a target station that has been assigned multiple resource units, each sequence of source data bits corresponding to a respective one of the resource units; encoding each sequence of source data bits of the multiple sequences of source data bits based on a respective coding rate to generate respective coded data bits sequences; and modulating each of the coded data bits sequences using respective modulation types to generate respective modulated code sequences that are each mapped to a respective set of subcarriers that correspond to a respective resource unit of the multiple resource units.

In some examples of the second aspect, the method includes selecting the respective coding rates and the respective modulation types based on a channel conditions in the wireless network for the respective sets of subcarriers that correspond to the multiple resource units, enabling different coding rates and modulation types to be applied to the sequences of source data bits that correspond to different resource units.

In one or more of the preceding examples of the second aspect the respective coding rates and respective modulation types are specified by predefined modulation and coding schemes (MCSs), wherein a different MCS is used for one of the sequences of source data bits corresponding to a respective resource unit than for one or more other sequences of source data bits.

In one or more of the preceding examples of the second aspect, the respective sets of subcarriers are non-contiguous with each other.

In one or more of the preceding examples of the second aspect, each set of subcarriers that corresponds to a respective resource unit comprises up to a total of 242 contiguous subcarriers.

In one or more of the preceding examples of the second aspect, the at least one of the sets of subcarriers includes a different number of subcarriers than one or more other sets of the subcarriers.

In one or more of the preceding examples of the second aspect, the sets of subcarriers all fall within a 20 MHz channel.

In one or more of the preceding examples of the second aspect, the method comprises interleaving each of the respective coded data bits sequences prior to modulating the respective coded data bits sequences.

According to a third examples aspect is a method of processing data for transmission in an Orthogonal Frequency-Division Multiple Access (OFDMA) wireless network, comprising: receiving an input data stream of source data bits that includes multiple sequences of data bits for transmission to a target station that has been assigned multiple resource units; encoding and modulating the multiple sequences of data bits to generate a stream of respective modulated sequences, the modulated sequences being coded and modulated using the same modulation and coding scheme and comprising a set constellation symbols for a set of subcarriers; and parsing the stream of modulated sequences to parse the modulated sequences to respective resource units corresponding to an OFDM symbol.

According to further example aspect a transmit station is described for transmitting data in an Orthogonal Frequency-Division Multiple Access (OFDMA) wireless local area network (WLAN). The transmit station includes a network interface configured to send and receive signals in the WLAN; a processing device coupled to the network interface; a non-transitory storage coupled to the processing device and storing thereon instructions that, when executed by the processing device, configure the transmit station to perform any of the methods of the preceding aspects.

According to a further example aspect is a transmitter for transmitting data in an Orthogonal Frequency-Division Multiple Access (OFDMA) wireless local area network. A transmitter, comprising: a binary convolutional coding (BCC) encoder configured to perform BCC encoding on a sequence of data bits that will be transmitted on multiple resource units (RUs) assigned to a STA; wherein the BCC encoding is performed by: applying ½ BCC encoding on the sequence of data bits to generate first and second sequences of coded bits for each RU; performing a puncturing operation to combine the first and second sequences of coded bits for each RU subject to a puncturing pattern determined based on a code rate that is indicated in a corresponding modulation and coding scheme (MCS) selected for each of the multiple RUs, wherein at least some of the RU's have a different selected MCS. In some examples, the BCC encoder comprises multiple puncturing operations each configured to use a respective puncturing pattern to perform the respective puncturing based on the corresponding code rate.

In some examples, the transmitter further comprises multiple interleavers each configured to perform an interleaving for each RU.

In some examples, the MCS type selected for one of the multiple RUs is different than that of the other RU.

According to a further example aspect is a transmitter that comprises: multiple RU processing paths wherein data bits are processed to be transmitted on multiple resource units (RUs) assigned to a STA; each RU processing path including: a binary convolutional coding (BCC) encoder configured to perform BCC encoding on a spatial stream and to generate coded bits on the spatial stream, wherein the BCC encoding depends on a code rate indicated by a corresponding MCS, the corresponding MCS being selected for each of the multiple RUs; and an interleaver configured to perform an interleaving of the generated coded bits on the spatial streams.

According to a further example aspect is a transmitter that comprises: a binary convolutional coding (BCC) encoder configured to perform BCC encoding on a sequence of data bits and to generate a sequence of coded bits that will be transmitted on multiple resource units (RUs) assigned to a STA; and an interleaver configured to perform an interleaving on the sequence of coded bits by using a matrix and generate an interleaved sequence, a number of the rows of the matrix and a number of the column of the matrix being determined based on respective modulation types indicated by respective MCSs selected for the multiple RUs.

According to further example aspects is a station including a transmitter as discussed above for use in a wireless area local area network (WLAN).

### BRIEF DESCRIPTION OF THE DRAWINGS

Reference will now be made, by way of example, to the accompanying figures which show example embodiments of the present application, and in which:

FIG. 1 illustrates an example of station (STA) resource allocation in 802.11ax.

FIG. 2 illustrates an example of MCS index values that each correspond to a respective modulation type and code rate.

FIG. 3 shows an example of multiple RUs allocated to one station according to an example embodiment.

FIG. 4 illustrates a detailed example of multiple RUs allocated to one station according to an example embodiment.

FIG. 5A is a block diagram illustrating an example communication network in accordance with one implementation of the present disclosure;

FIG. 5B is a block diagram illustrating an example of a transmitter that cane be used in the communication network;

FIG. 6A is a block diagram illustrating components of a transmitter in accordance with one implementation of the present disclosure;

FIG. 6B is a block diagram illustrating a BCC encoder of the transmitter of FIG. 6A;

FIG. 7 is a block diagram illustrating components of a transmitter in accordance with an alternative implementation of the present disclosure;

FIG. 8 is a block diagram illustrating components of a transmitter in accordance with a further alternative implementation of the present disclosure;

FIG. 9 is a block diagram illustrating the interleaver of the transmitter of FIG. 8;

FIG. 10 illustrates a table that is applied in the interleaver of FIGS. 8 and 9 in a table illustrating a table;

FIG. 11 illustrates a method implemented by the interleaver of FIG. 8 in accordance with example embodiments;

FIG. 12A is a block diagram illustrating components of a receiver in accordance with an implementation of the present disclosure;

FIG. 12B is a block diagram illustrating components of a receiver in accordance with a further implementation of the present disclosure;

FIG. 12C is a block diagram illustrating components of a receiver in accordance with a further implementation of the present disclosure;

FIG. 13 illustrates example frame format for exchanging information through a wireless medium of the communication network of FIG. 5A; and

FIG. 14 is a block diagram illustrating a processing system which may be used in one or more stations of the communication network of FIG. 5A according to example embodiments.

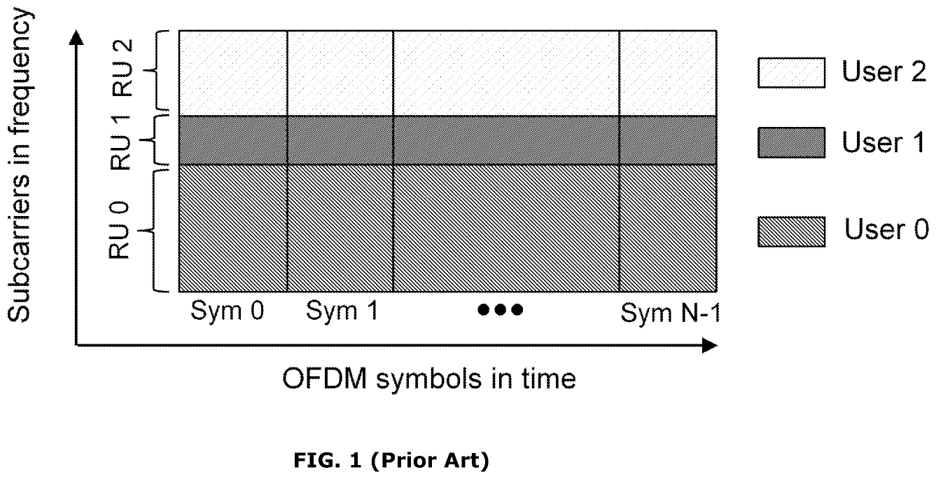

Like reference numerals are used throughout the Figures to denote similar elements and features. Though aspects of the invention will be described in conjunction with the illustrated embodiments, it will be understood that it is not intended to limit the invention to such embodiments.

### DETAILED DESCRIPTION OF EXAMPLE EMBODIMENTS

The present disclosure teaches methods, devices, and systems for transmitting data in a wireless network, such as next generation wireless local area network (WLAN) systems, including for example next generation Wi-Fi systems such as the EHT system proposed under the developing IEEE 802.11be protocol.

Under IEEE 802.11ax, an MCS is selected for an RU based on channel or link conditions for data transmission. In particular, the channel conditions are measured and averaged over all the subcarriers of the RU assigned to a station, and the average result is used to select an appropriate MCS. However, for multi-RU transmissions proposed under IEEE 802.11be, link or channel conditions across the respective subcarrier groups allocated to the different RUs assigned to a particular station within a frequency band may vary substantially. Thus, selecting a common MCS for all station specific RUs can provide sub-optimal results as channel decoding performance will be dominated by the worst channel among the multi-RUs. In contrast, if a different MCS is selected for each RU, channel performance within each RU can be optimized based on the measured channel conditions for that RU.

Accordingly, in example embodiments, the present disclosure provides examples of transmitter configurations that support different MCSs for the different RUs allocated to a station for an OFDM symbol. The disclosed transmitter and method for transmitting data may help to alleviate interference and channel gain differences that result from using spaced-part RU's.

As will be explained in greater detail below, in a first multi-RU example, a transmitter includes a common BCC encoder that is used to apply BCC encoding to the data for all RUs intended for a receiving station, followed by RU-specific interleaver and modulator operations that interleave and modulate the data for each RU to enable a different respective MCS to be used for each RU. In such examples, the common BCC encoder is configured to change a puncturing pattern within the data of a single OFDM symbol to enable the corresponding code rate indicated by the respective MCS for each RU.

In a second multi-RU example embodiment, respective interleaver and BCC encoder and modulator operations are applied for each RU to enable the RUs to be transmitted with different respective MCSs.

In a third example embodiment, common BCC encoder, interleaver and modulator operations are used for the multi-RUs with an identical MCS. An interleaver operation is used to implement frequency diversity gain and minimize the performance loss caused from the different SINR level between multiple RUs even though the same MCS is applied to the multiple RUs. Even though the purpose of the third example may be to apply the same MCS across multiple RUs, technically, it can also allow different MCS to be applied across multiple RUs.

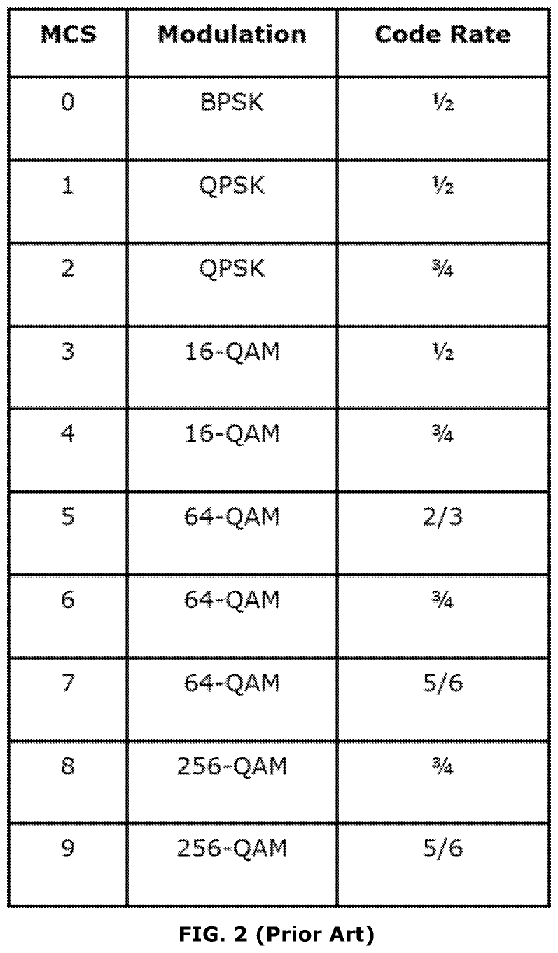

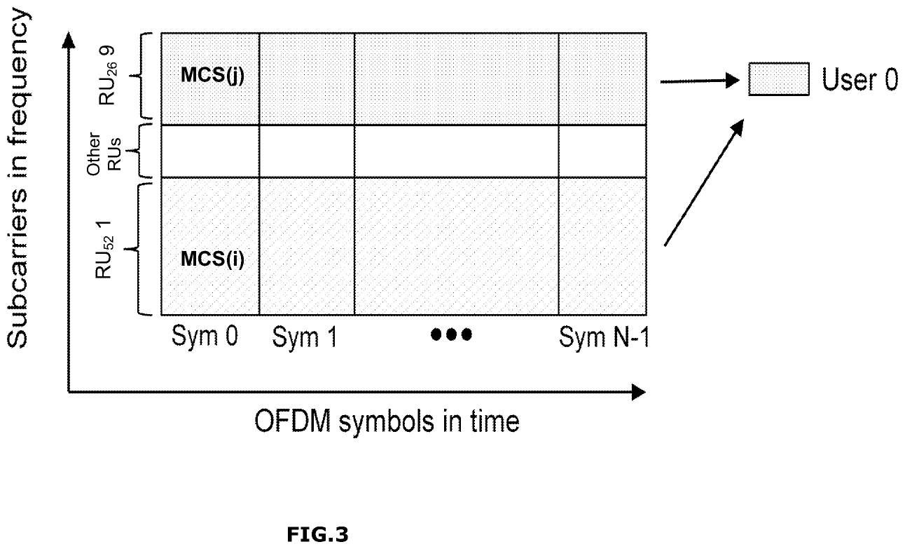

FIG. 3 illustrates an example of multiple RUs assigned to a single station (User 0) according to example embodiments. In the example of FIG. 3, the STA (User 0) has been assigned two non-contiguous RUs, namely 52 tone RU1 and and 26 tone RU9, each of which includes (e.g., can be used to transmit) a plurality of OFDM symbols Sym 0 to Sym N−1 within a PPDU. A first MCS, namely MCS(i), is used for modulating and encoding data that is transmitted using the first resource unit (e.g., RU 1), and a second MCS, namely MCS(j), is used to for modulating and encoding data that is transmitted using the second resource unit (e.g., RU9). In example embodiments, MCS(i) is selected for the first RU1 based on the link conditions measured in respect of the set of subcarriers associated with RU1, and MCS(j) is selected for the second RU9 based on wireless channel conditions measured in respect of the set of subcarriers associated with RU9. In some examples, the MCS(i) for the first RU1 and MCS(j) for the second RU9 can be identical or different, which can be any type of MCS as shown in FIG. 2.

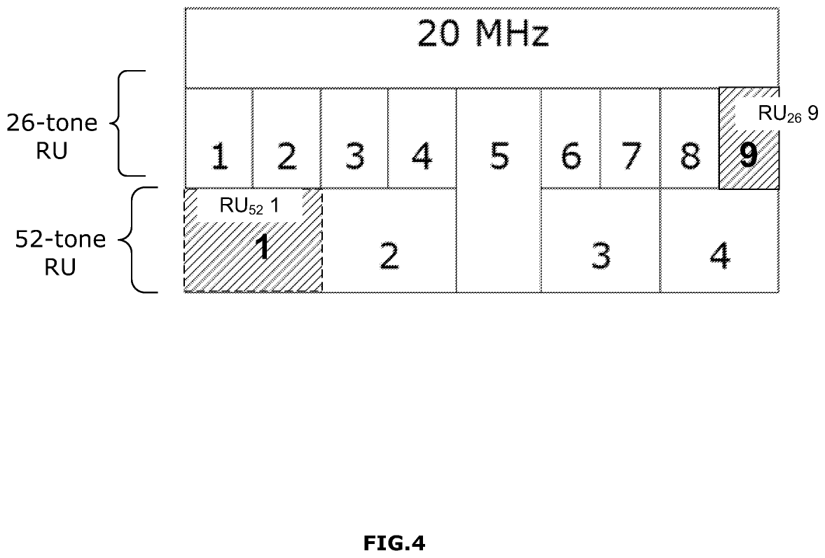

With reference to FIG. 4, the RU assignments of FIG. 3 are illustrated in a different format. The multiple RUs 52 tone RU1 and 26 tone RU9 are allocated in a 20 MHz operating channel. RU1 and RU9 are each small size RUs. In the present disclosure, a small-size RU is an RU having 242 or less subcarriers and a large-size RU is an RU that has more than 242 subcarriers. A small-size multi-RU refers to a combination of small-size RUs. In example embodiments, the multi-RU assigned to a station can include different size combinations of small-size RUs. For ease of illustration, the small-size multi-RU examples the combination of a 52-tone RU and a 26-tone RU and the combination of a 106-tone RU and a 26-tone RU will be discussed below.

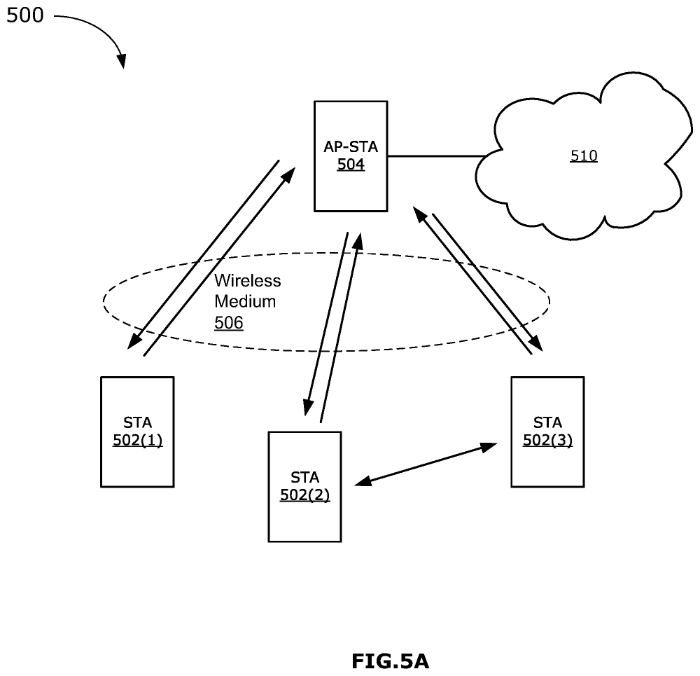

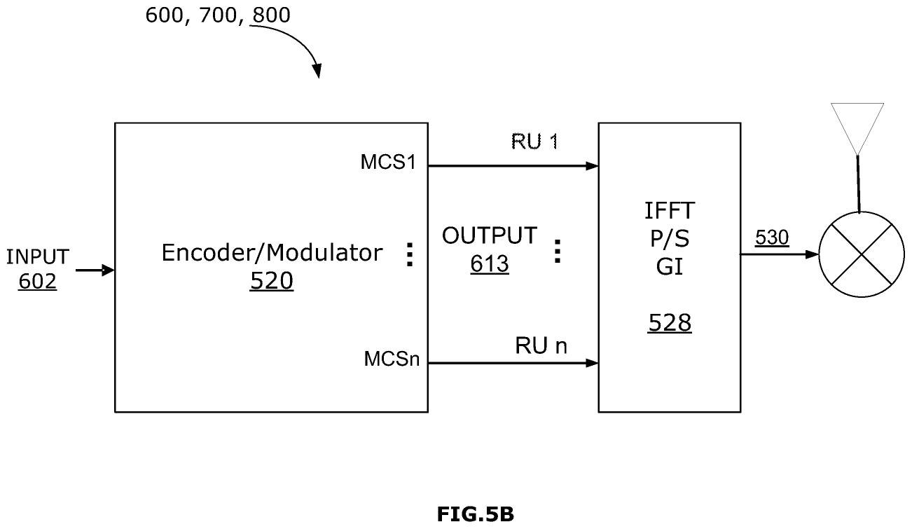

An example network environment in which a small-size multi-RU is allocated to a station is illustrated with reference to FIG. 5. FIG. 5 presents a wireless communication network 500 comprising a plurality of stations (STAs)(e.g., 502(1)-(3), generically referred to as 502) that can include fixed, portable, and moving stations. The network 500 may operate according to one or more communications or data standards or technologies; however, in at least some examples the network 500 is a WLAN and in at least some examples is a next generation Wi-Fi compliant network that operates in accordance with one or more protocols from the 802.11 family of protocols.

Each STA 502 may be a laptop, a desktop PC, PDA, Wi-Fi phone, wireless transmit/receive unit (WTRU), mobile station (MS), mobile terminal, smartphone, mobile telephone, sensor, internet of things (IOT) device, or other wireless enabled computing or mobile device. In some embodiments, a STA 502 comprises a machine which has the capability to send, receive, or send and receive data in the communications network 500 but which performs primary functions other than communications. An access-point station (AP-STA) 504 may comprise a network access interface which functions as a wireless transmission and/or reception point for STAs 502 in the network 500. The AP-STA 504 may be connected to a backhaul network 510 which enables data to be exchanged between the AP-STA 504 and other remote networks (including for example the Internet), nodes, APs, and devices (not shown). The AP-STA 504 may support communications through unlicensed radio frequency spectrum wireless medium 506 with each STA 502 by establishing uplink and downlink communication links or channels with each STA 502, as represented by the arrows in FIG. 5. In some examples, STAs 502 may be configured to communicate with each other. Communications in the network 500 may be unscheduled, scheduled by the AP-STA 504 or by a scheduling or management entity (not shown) in the network 500, or a mix of scheduled and unscheduled communications.

Three different example aspects of the present disclosure are described in the context of respective transmitters 600, 700 and 800. By way of context, FIG. 5B illustrates an example of selected components of a transmitter 600, 700 or 800 that may be present in a STA, for example AP-STA 504 according to example embodiments. In example embodiments, RUs have been allocated to use for data transmission among the multiple STAs 502, and multiple non-contiguous RUs (e.g., RUi and RUj) have been assigned to the same STA 502. In example embodiments, the AP-STA 504 acquires information about link conditions through the wireless medium 506 for the RUs assigned to STAs 102. Based on that information, the AP-STA 504 selects an optimal MCS for each RU from a predefined set of available MCSs. In an example embodiment, the link conditions for RUi and RUj are determined to be sufficiently different that a different optimal MCS (e.g. MCS(i) and MCS(j) is selected for encoding and modulating for RUi and RUj.

The transmitter 600, 700 or 800 receives a serial stream of data bits as input 602. In example embodiments, the input 602 includes data bits that are to be included in the physical layer (PHY) payload (e.g., the PHY service data unit (PSDU) of a multi-RU physical layer (PHY) protocol data unit (PPDU)). An encoder/modulator 520 of the transmitter is configured to generate an output 613 of n respective sets of modulated code sequences MCS1 to MCSn, each of which corresponds to a respective RU 1 to RU n. Each of the modulated codesequences MCS1 to MCSn includes a respective coded bit sequence that has been mapped to a respective sets of subcarriers or tones that correspond to RU 1 to RU N using a respective modulation constellation (e.g., BPSK, QPSK, 16-QAM, 64-QAM, 256-QAM, 1024-QAM, 2048-QAM, 4096-QAM).

As will be explained in greater detail below, each transmitter 600, 700, 800 incorporates a different encoder/modulator 520 configuration. In example embodiments, further processing operations 528 are applied to the n outputs 613 to generate output 530. In example embodiments further processing operations 528 include an inverse fast Fourier transform (IFFT) operation on each of the n subcarriers, followed by a parallel to serial (p/s) conversion and the addition of a guard interval (GI). The resulting output is a stream of OFDM symbols for inclusion in a PHY payload (e.g., PSDU) of a PPDU.

In example embodiments, the output 530, which corresponds to the data portion (e.g., PHY payload) of a PPDU, is appended to a PHY header to provide a PPDU that is modulated onto a carrier frequency and transmitted through wireless medium 506.

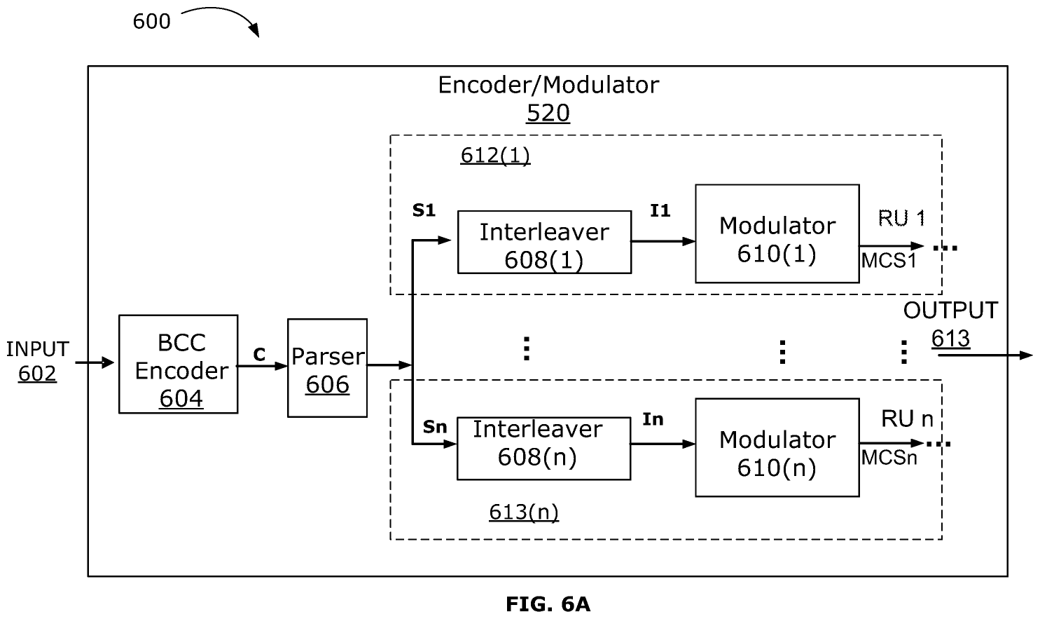

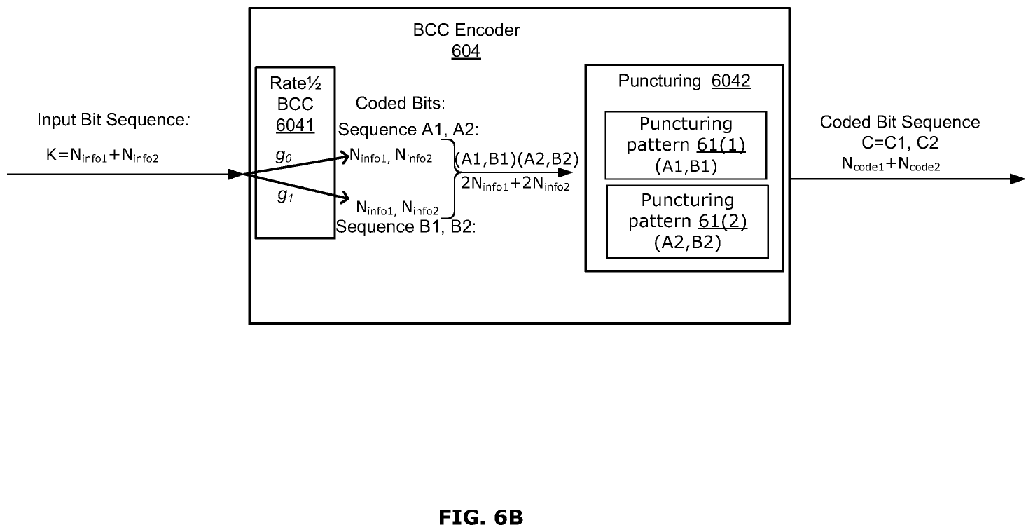

An example of a configuration for encoder/modulator 520 according to a first aspect will now be described with reference to FIG. 6A, which illustrates selected components of transmitter 600 that may be present in a STA, for example the AP-STA 504. The transmitter 600 applies different MCSs for modulating and encoding data over multiple RUs (e.g., non-contiguous) in the small-size RUs that have been assigned to a same STA (e.g., User 0). The number of MCSs equals to the number of the multiple RUs (e.g., n). Based on link conditions through the wireless medium 506 for the multiple RUs of the small-size RU assigned to the single STA 502, the AP-STA 504 selects a respective MCS for each RU of the small-size RU for a predefined set of available MCSs (e.g., from MCS indexes as shown FIG. 2). In the example of FIG. 6A, the n selected MCSs (e.g., modulation type and/or code rate) may be different with respect to each other.

The output 613 takes the form of constellation mapped information for one or more OFDM symbols that will be included in a physical layer (PHY) service data unit (PSDU). In this regard, the transmitter 600 receives a serial stream of data bits for the PSDU as input 602. The input 602 includes data bits that are to be included in the PHY payload (e.g., the PSDU of a physical layer (PHY) protocol data unit (PPDU)). The BCC encoder 604 applies n different BCC encoding rates to the data bits of the input 602 and generates a coded bit sequence C for the n RUs. For each RU, a respective BCC encoding (e.g., code rate) is determined based on a corresponding MCS selected for the RU. The BCC encoding applied to the data bits of the input 602 for a single OFDM symbol based on the n different MCSs will be illustrated in greater detail below. A bit parser 606 then divides the coded bit sequence C from the BCC encoder 604 into respective coded bit sequences S1 to Sn that each correspond to a respective RU (e.g., RU 1 to RU n). Coded bit sequences S1 to Sn are each processed by a respective processing path 612(i) that includes a respective interleaver 608(i) and modulator 610(i) at which a different modulation type as specified by a respective MCS is applied.

The interleaver 608(i) changes order of bits of the corresponding coded bits Si received from the parser 606 and generates an interleaved sequence Ii, which may help to prevent long sequences of adjacent noisy bits from entering a BCC decoder. The modulator 610(i), which in example embodiments is a constellation mapper, then maps the interleaved bits of sequence Ii to constellation points (a complex number) based on a modulation type associated with the MCS selected for the RUi.

Reference is now made to FIG. 6B, which now illustrates a BCC encoder 604 configured to perform BCC encoding on the data bits of input source data bit stream 602. In example embodiments the BCC encoder 604 is configured to apply different coding rates to the bits that are assigned to different RUs of a multi-RU based on a respective MCS for each RU. The BCC encoder 604 includes a BCC operation 6041 and a puncturing operation 6042 that can be configured to selectively apply different puncturing patterns 61(i) where i∈{1, . . . , n}). In an illustrative example that will now be described, n=2, with RU1 and RU2 referring to two respective non-contiguous small-size RUs) that are allocated to a single STA 502 for an OFDM symbol included in a PPDU. An input sequence of K=N_{info1}+N_{info2} bits is received at the BCC encoder 604, where N_{info1} is the number of source data bits that will be represented in information transmitted using RU0 and N_{info2} is the number of source data bits that will be represented in information transmitted using RU1. The number N_{info(i)} of source data bits received at BCC encoder 604 for a respective RUi is represented by the following equation (1):

N_{info(i)}=N_{DSRU(i)}×N_{BPSC(i)}×Cᵣ₍ᵢ₎ (1)

Where in this example, where i∈{1, . . . , n}; N_{DSRU(i)} defines the number of subcarriers per RU for RUi, N_{BPSC(i)} represents the number of bits per subcarrier, and Cᵣ₍ᵢ₎ is a code rate determined based on the selected MCS for the RUi.

The BCC operation 6041 performs a rate ½ BCC encoding on the K=N_{info1}+N_{info2} bits of the input bit stream and generates 2(N_{info1}+N_{info2}) coded bits. In particular, in the case of n=2, the BCC operation 6041 performs rate ½ BCC encoding on the N_{info1} bits that correspond to RU1 by applying a first generator polynomial gₒ and a second generator polynomial g₁ to the N_{info1} bits to generate a first N_{info1} bit length sequence A1 and a second N_{info1} bit length sequence B1. The BCC operation 6041 also performs rate ½ BCC encoding on the N_{info2} bits that correspond to RU2 by applying the first generator polynomial gₒ and the second generator polynomial g₁ to the N_{info2} bits to generate a first N_{info2} bit length sequence A2 and a second N_{info2} bit length sequence B2. The coded sequences (A1, B1) and (A2, B2) are each respectively subjected to puncturing by a puncturing operation 6042.

In the example of FIG. 6B, puncturing operation 6042 combines the bits from the sequences A1,B1 by alternatively selecting bits from sequences A1 and B1 subject to a first puncturing pattern 61(1) that corresponds to the MCS specified code rate for RU1, resulting in a first coded punctured sequence C1 of N_{code1} bits. Puncturing operation 6042 then combines the bits from the sequences A2, B2 by alternatively selecting bits from sequences A2 and B2 subject to a second puncturing pattern 61(2) that corresponds to the MCS specified code rate for RU2, resulting in a second coded punctured sequence C2 of N_{code2} bits. The puncturing pattern specifies bits that are to be omitted from the combined sequence 2 (N_{info1}+N_{info2}). The number of bits, N_{code(i)} is defined by following equation (2):

N_{code(i)}=N_{info(i)}/Cᵣ₍ᵢ₎ (2)

The output of BCC encoder 604 is punctured coded sequence C of length N_{code1}+N_{code2}, which includes: punctured coded bit sequence C1 of length N_{code1}, corresponding to bits for RU1; and punctured coded bit sequence C2 of length N_{code2}, corresponding to bits for RU2. Thus, BCC encoder 604 is configured to enable the puncturing pattern 61(i) that is applied to change while the bits corresponding to a single OFDM symbol are being encoded, thereby enabling different coding rates to be applied to different groups of bits for the different RUs allocated for an OFDM symbol for a specific STA.

Referring again to FIG. 6A, as noted above, the parser 606 then divides the coded bit sequence C from the BCC encoder 604 into coded bit sequences S1, S2, where the bits of punctured coded sequence C1 are parsed into sequence S1, and the bits of punctured coded sequence C2 are parsed into sequence S2. The configuration of transmitter 600 BCC encoder 604 may enable a different respective MCS specified code rate to be applied at common BCC encoder 604 for every single RU within the small-sized multi-RU. Additionally, a different MCS specified modulation can be applied at the RU-specific modulators 610(1) to 610(n).

In one example, for a small-size multi-RU configured with a 26-RU 9 and a 52-RU 1 as shown in FIG. 4, each RU is scheduled with a different respective MCS (26-RU 9 is scheduled with MCS 5 (64 Quadrature amplitude modulation (QAM), code rate: ¾) and 52-RU 1 is scheduled with MCS 7 (64 Quadrature amplitude modulation (QAM), code rate: ⅚), in at least some scenarios the average SNR across the small-size multi-RU may be reduced, which in turn help to improve channel gain of transmission over the small-size multi-RU. “Goodput” is a performance parameter defined as the number of correctly decoded information bits per packet divided by the total airtime per packet. The goodput for the configuration (26-RU is associated with MCS 5 and 52-RU is associated with MCS 7) of the small-size multi-RU may, in at least some cases, be improved by using the BCC encoder 604 with multiple puncturing operations 6042. It is noted that according to example embodiments, multiple disclosed herein means the number is greater than or equal to 2.

A method of performed by the transmitter 600 for processing data for transmission in wireless network 506 can be summarized as follows. An input data stream 602 of source data bits is encoded using a first coding rate (e.g., ½ rate) to generate a data stream of multiple sets of coded bits (e.g., [A1,B1], [A2,B2]) for a target station 502 that has been assigned multiple resource units RU1 to RU n, each set of coded bits corresponding to a respective one of the resource units RU1 to RU n. Each of the multiple sets of coded bits in the data stream is punctured using a respective puncturing pattern (e.g., 61(1), 61(2)) to generate respective punctured coded data bits sequences (e.g., C1, C2) that each correspond to a respective coding rate, wherein at least some of the respective puncturing patterns are different. Each of the punctured coded data bits sequences using is modulated respective modulation types (e.g., by modulators 610(1) to 610(n)) to generate respective modulated code sequences that are each mapped to a respective set of subcarriers that correspond to a respective resource unit of the multiple resource units Ru 1 to Ru n.

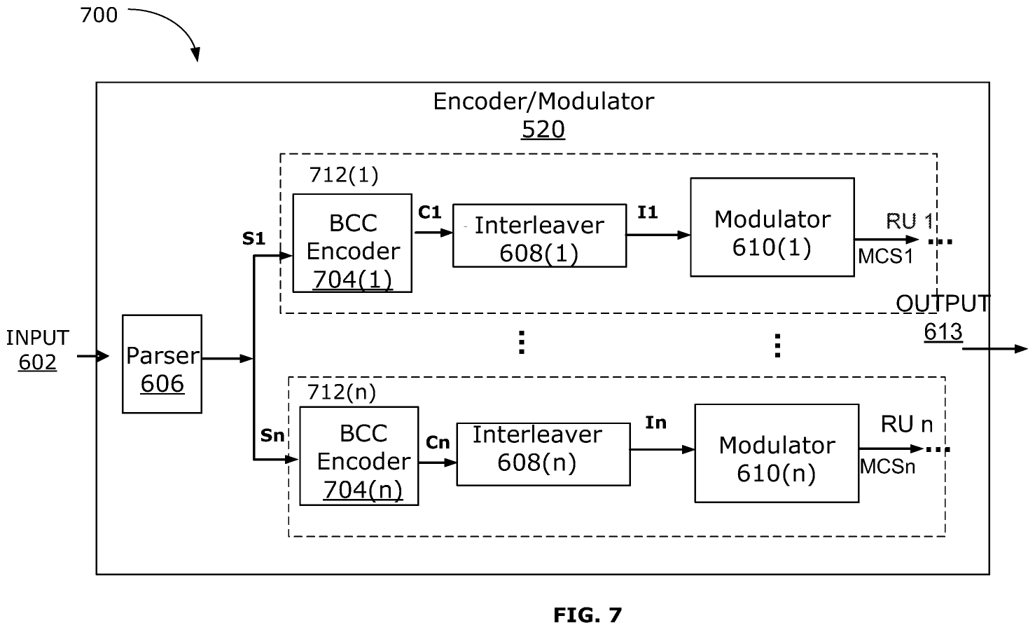

FIG. 7 illustrates another example of a configuration for encoder/modulator 520 in the context of transmitter 700, which can be used to transmit payload data allocated over multiple RUs of a small-size multi-RU for a single STA. The transmitter 700 can be used in a case where each RU corresponds to a different MCS as well. The transmitter 700 may be present in an AP, for example AP-STA 504 according to example embodiments. In the example of FIG. 7, the transmitter 700 is similar in operation to the transmitter 600 described in FIG. 6A except that the encoder/modulator 520 of transmitter 700 applies a different respective BCC encoder 704(1)-(n) (generically referred to as a BCC encoder 704) on every single RU processing path 712(i).

In this regard, the transmitter 700 receives a serial stream of data bits as input 602 that are to be included in a PSDU of a multi-RU PPDU. The parser 606 parses the data bits of the input 602 into n parallel S1 to Sn, each of which corresponds to a respective RU 1 to RU n. In an example embodiment, at least two data bit sequences (e.g., Si and Sj) include data that is intended for the same STA 502. On each RU processing path 712, BCC encoding is applied to each of the data bit sequences S1 to Sn by a respective BCC encoder 704. In some example embodiments, data bit sequence S1 to Sn are each encoded by a rate ½ BCC encoding operation into coded bits that are punctured by a respective puncturing pattern into a respective punctured sequence, also called coded bit sequence C (e.g., C1 to Cn). The puncturing pattern on each RU processing path 712 is determined by a coding rate (e.g., ½, ⅔, ¾, ⅚), and the coding rate is specified by a MCS (e.g., MCS(i) or MCS(j)) that is associated with the corresponding RU. In some examples, the MCS may be selected based on link conditions of the corresponding RU assigned for transmission between the AP-STA 504 and the single STA 502. The RU processing path 712(1) as denoted by a dashed box is illustrated as an example of a respective RU processing path 712. The coded bits of the coded bit sequence C1 are then reordered at a respective interleaver 608(1) in order to alleviate adjacent noisy bits in long sequences, and a respective interleaved sequence I1 is then generated as an input at a modulator 610(1). The modulator 610(1) modulates the interleaved sequence I1 to maps the sequence to constellation symbols that for respective subcarriers. Modulation type applied at each modulator 610 is determined by the MCS selected for the respective RU. Accordingly, the modulation applied to the interleaved sequence I is determined by the modulation constellation specified by MCS(i) and MCS (j), respectively, resulting in respective RU i and RU j.

The transmitter 700 provides a different respective BCC encoder 704 and a corresponding interleaver 608 for every single RU associated with a selected MCS. Therefore, in the case where each RU of the small-size multi-RU is scheduled with a MCS different than that of other RUs of the small-size multi-RU, such configuration may help to improve goodput and reduce SNR without making any changes either in the BCC encoder 702 or the interleaver 608 on any RU processing path of the transmitter 700.

A method of performed by the transmitter 700 for processing data for transmission in wireless network 506 can be summarized as follows. An input data stream 602 is parsed to generate multiple sequences S1 to Sn of source data bits for a target station that has been assigned multiple resource units RU1 to RU n, each sequence of source data bits S1 to Sn corresponding to a respective one of the resource units RU 1 to RU. Each sequence of source data bits S1 to Sn of the multiple sequences of source data bits is encoded based on a respective coding rate to generate respective coded data bits sequences C1 to Cn. Each of the coded data bits sequences C1 to Cn is modulated using respective modulation types (e.g., by respective modulators 610(1) to 610(n) to generate respective modulated code sequences MCS1 to MCSn that are each mapped to a respective set of subcarriers that correspond to a respective resource unit RU 1 to RU n of the multiple resource units.

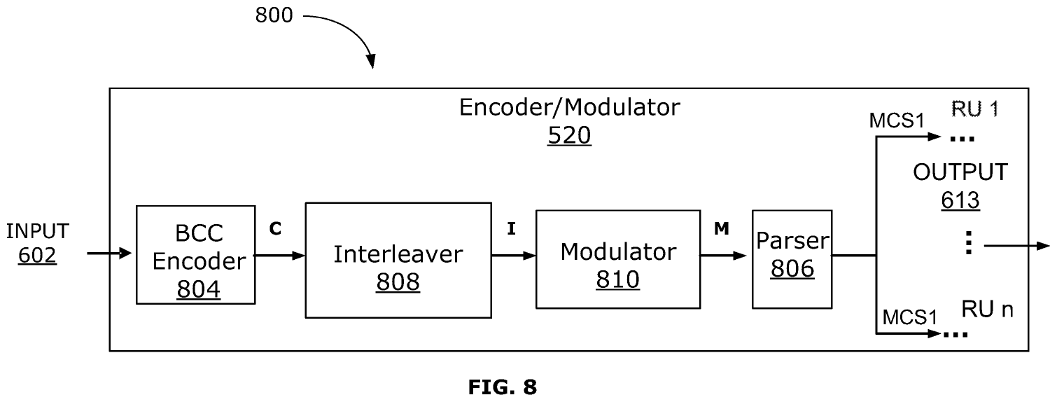

Referring to FIG. 8, a third configuration of an encoder/modulator 520 is illustrated in the context of transmitter 800. Transmitter 800 applies an identical MCS for all the RUs in a small-size multi-RU, in accordance with a further example embodiment. The encoder/modulator 520 of transmitter 800 includes a common BCC encoder 804, interleaver 808, and modulator 810, followed by a constellation symbol parser 806 that parses the modulated symbols according to respective RUs. As explained below, transmitter 800 may in some applications help to reduce performance degradation due to different interferences and channel gain between multiple RUs. The transmitter 800 receives a serial stream of data bits as input 602. The common BCC encoder 804 applies a BCC encoding on the serial stream and outputs a coded bit sequence C. The operation of the common BCC encoder 804 is identical to that of any of BCC encoders 704(1)-(n) as shown in FIG. 7. The puncturing pattern used in the BCC 804 is determined based on a code rate specified in the identical MCS for all the RUs within the small-size multi-RU. The interleaver 808 then interleaves coded bits of the coded bit sequence C and produces an interleaved sequence I. The interleaver 808 may be a block interleaver, as disclosed further below. The modulator 810 then modulates the interleaved sequence I onto constellation symbols for a plurality of subcarriers and generates a modulated sequence M. Modulation type applied in the modulator 810 is determined by the identical MCS for all the RUs. The modulated sequence M is then parsed at a parser 806 into n parallel modulated sequences MCS1 to MCSn for the n RUs. Configuration and operation of the modulator 810 are similar to those of any modulator 610 as shown in FIG. 6, and the parser 806 is a constellation parser that parses the modulated sequences MCS1 to MCSn by RU assignments.

The configuration of the interleaver 808 and three-step permutations implemented by the interleaver 808 will be now discussed in greater detail. As noted above, the interleaver 808 in this example of FIG. 8 may be a block interleaver. This is only illustrative and is not intended to be limiting. In some other examples, the interleaver 808 may be a pseudo-random interleaver or a convolutional interleaver.

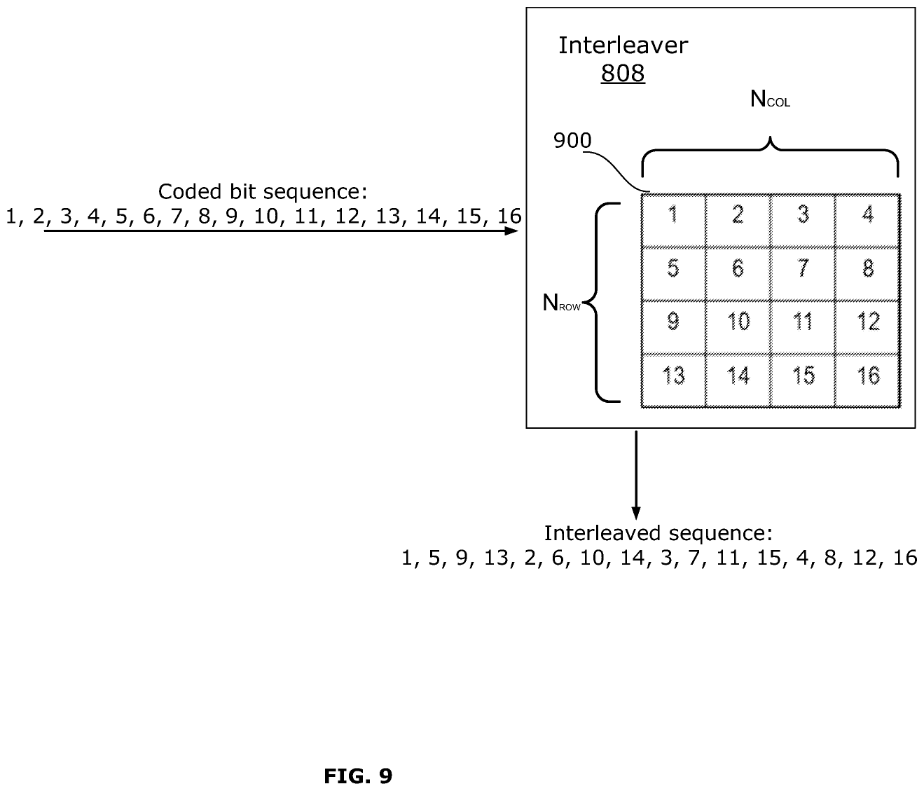

In this regard, FIG. 9 presents an example of how to use the interleaver 808 to change order of coded bits of a coded bit sequence C, acting as an input sequence of the interleaver 808, and to generate an interleaved sequence by using a matrix 900 with N_{ROW} rows and N_{COL} columns. As shown in FIG. 9, given the coded bit sequence is (1, 2, 3, 4, 5, 6, 7, 8, 9, 10, 11, 11, 13, 14, 15, 16), when the interleaver 808 performs the interleaving, the input sequence sequentially enters in the interleaver 802 by N_{ROW} rows, and all the coded bits stored in the matrix 900 are then read out by N_{COL} columns. Therefore, the interleaved sequence is produced as (1, 5, 9, 13, 2, 6, 10, 14, 3, 7, 11, 15, 4, 8, 12, 16). In some examples, a step for entering the input sequence in N_{ROW} rows is referred to as a first permutation, and a step for reading the coded bits stored in the matrix 900 out in N_{COL} columns is referred to as a second permutation. In some other examples, if more than one spatial stream exists after the first and second permutation have been applied, a third permutation called frequency rotation will be applied to the additional spatial streams. The parameter for the frequency rotation is denoted as N_{ROT}.

In the standard 802.11ax, parameters N_{ROW}, N_{COL}, and N_{ROT} that are used for the interleaving are predefined for every individual RU based on the individual RU size, such as 26 tones, 52 tones, 106 tones, or 242 tones. However, in the case where a small-size multi-RU, for example, including combination of a 26-RU and a 52-RU, or a combination of a 26-RU and a 106-RU, is employed to be assigned to a single STA, parameters N_{ROW}, N_{COL}, and N_{ROT} for the three permutations need to be re-defined based on the size (e.g., 26+52=78 tones, 26+106=132 tones) of the combined RUs or multi-RUs within the small-size multi-RU.

In this regard, the parameters N_{ROW}, N_{COL}, and N_{ROT} are defined based on the different combination of RUs within the small-size multi-RU, in accordance with example embodiments. The defined parameters N_{ROW}, N_{COL}, and N_{ROT} may help the interleaver to perform the permutations accurately and efficiently in the scenario where the small-size multi-RU is applied.

Given a small-size multi-RU includes two RUs, a first RU and a second RU, such as 52-RU and 26-RU, or 106-RU and 26-RU, and transmission applying the small-size multi-RU is operated in a channel width 20 MHz, the first permutation is defined by following equation (3):

$$i = {N}_{ROW} ( k mod {N}_{COL} ) + ⌊ \frac{k}{{N}_{COL}} ⌋ , \\ k = 0 , 1 , … , {N}_{CBPS} - 1 \qquad ( 3 )$$

Where k represents an index of the input sequence to the interleaver 808 before the first permutation is performed, and i represents an index as output of the first permutation before the second permutation is performed. N_{ROW} equals to (RL0+RL1)/N_{COL}, RL0 is the number of coded bit in total for the first RU, and RL1 is the number of coded bit in total for the second RU. N_{CBPS} is the number of coded bits per OFDM symbol. N_{ROW} and N_{COL} will be explained further below.

The second permutation is defined by following equation (4):

$$j = s ⌊ \frac{i}{s} ⌋ + ( i + {N}_{CBPS} - ⌊ \frac{i \cdot {N}_{COL}}{{N}_{CBPS}} ⌋ ) mod s , \\ i = 0 , 1 , … , {N}_{CBPS} - 1 \qquad ( 4 )$$

Where j is the output of the second permutation, and s is (2×N_{BPSC0}+N_{BPSC1})/2 for the case where the small-size multi-RU includes the 52-RU (corresponds to N_{BPSC0}) and 26-RU (corresponds to N_{BPSC1}), and s is (51×N_{BPSC0}+12×N_{BPSC1})/2 when the small-size RMU includes the 106-RU (corresponds to N_{BPSC0}) and 26-RU (corresponds to N_{BPSC1}). N_{BPSC0} is the number of coded bits per subcarrier for the first RU, and N_{BPSC1} is the number of coded bits per subcarrier for the second RU. N_{BPSC0} and N_{BPSC1} are determined by a respective selected MCS. In this example, an identical MCS is employed for the first and second RU.

If more than one spatial stream exist, a frequency rotation (third permutation) is applied to the output of the second permutation by performing equation (5) as below:

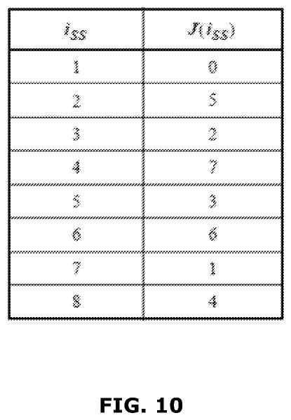

r=(j−J(iₛₛ)N_{RUT}(2N_{PCSCU}+N_{BPSC1})mod N_{CBPS}i=0,1, . . . N_{CBPS}−1 (5)

Where r is the output of the third permutation, and N_{ROT} is set to 11 for the operating channel width 20 MHz. iₛₛ is the spatial stream index on which this interleaver is operating, and J(iₛₛ) is an interger as defined in FIG. 10. When r becomes less than 0, r=N_{CBPS}+r.

In this example, the interleaver 808 is only applied to the coded bits without pilot tones. Thus, for a small-size multi-RU with 78 tones, 72 coded bits are used, and 126 coded bits can be used for a small-size multi-RU with 132 tones. N_{ROW} and N_{COL} will be now introduced in greater detail. For the small-size multi-RU, N_{ROW} is defined by following equation (6):

N_{ROW}=(the number of coded bit in total in the small-size multi-RU)/N_{COL} (6)

Where the number of coded bits in total in the small-size multi-RU equals RL0+RL1; RL0 is the number of coded bit in total for the first RU that excludes pilot tones, and RL1 is the number of coded bit in total for the second RU that excludes pilot tones. RL0 and RL1 are represented by following equations (7) and (8)

RL0=DRL0×N_{BPSC0}; (7)

RL1=DRL1×N_{BPSC1}; (8)

Where DRL0 is the actual number of subcarriers for only the data tones excluding the pilot tones for the first RU, and DRL1 is the actual number of subcarriers for only the data tones excluding the pilot tones for the second RU. Thus, the equation (6) can be transformed to equation (9) as below:

N_{ROW}=(RL0+RL1)/N_{COL}=(DRL0×N_{BPSC0}+DRL1×N_{BPSC1})/N_{COL} (9)

Accordingly, for the small-size multi-RU with 52-RU (having 48 data tones, with the 4 pilot tones being excluded) and 26-RU (excluding 2 pilot tones and having 24 data tones), DRL0=48 and DRL1=24. If N_{COL} is set to equal to 24, then N_{ROW} equals to (2×N_{BPSC0}+N_{BPSC1}) by applying DRL0=48, DRL1=24, and N_{COL}=24 in the equation (9). If N_{COL} is set to equal to 12, N_{ROW} equals to (2×(2×N_{BPSC0}+N_{BPSC1})) by applying DRL0=48, DRL1=24, and N_{COL}=12 in the equation (9).

For the small-size multi-RU with 106-RU (excludes 4 pilot tones and has 102 data tones) and 26-RU (excludes 2 pilot tones and has 24 data tones), DRL0=102 and DRL1=24. If N_{COL} is set to equal to 2, N_{ROW} equals to (51×N_{BPSC0}+12×N_{BPSC1}) by applying DRL0=102, DRL1=24, and N_{COL}=2 in the equation (9).

As discussed above, N_{COL} is set to equal to 24 in the case of combination of 52-RU (has 48 data tones and excludes 4 pilot tones) and 26-RU (excludes 2 pilot tones and has 24 data tones), the value of N_{COL} (e.g., 24) is set to be the greatest common divisor among 48 and 24. Similar, in the case of combination of 106-RU (has 102 data tones and excludes 4 pilot tones) and 26-RU (excludes 2 pilot tones and has 24 data tones), the value of N_{COL} (e.g., 2) is also set to be the greatest common divisor among 102 and 24.

In this regard, N_{COL}, disclosed herein, is defined as a greatest common divisor (gcd) of the number of subcarriers corresponding to data tones for the first RU (DRL0) and the number of subcarriers corresponding to data tones for the second RU (DRL1).

In accordance with the example of FIGS. 8-10 and equations (3)-(9), for a small-size multi-RU, including a first RU and a second RU, collectively assigned to a single STA with the identical MCS, the interleaver 808 performs a first permutation by writing coded bits of the coded bit sequence C output from the BCC encoder 804 in a matrix by N_{ROW} rows, and generates intermediate output stored in the matrix as represented by the equation (3). Subsequently, the interleaver 808 performs a second permutation by reading each coded bit stored in the matrix out by N_{COL} columns. N_{COL} is defined by finding a greatest common divisor between the number of the subcarriers that carry data tones for the first RU (DRL0) and the number of subcarriers that carry data tones for the second RU (DRL1). N_{ROW} equals to (a number of coded bit in total across the first RU and the second RU)/N_{COL}. The number of coded bit in total across the first RU and the second RU is determined based on a modulation type specified in the identical MCS, which is used for both the first and second RU.

In accordance with the equations (7) and (8), as a number of coded bits per subcarrier for the first RU N_{BPSC0} depends on the modulation type of the identical MCS, and a number of coded bits per subcarrier for the second RU N_{BPSC1} depends on the modulation type of the identical MCS, the identical MCS determines a first number of coded bit (RL0) in total across the first RU, denoted by the equation (7), and a second number of coded bit (RL1) in total across the second RU, denoted by the equation (8). Therefore, N_{ROW} is determined based on a modulation type indicated in a MCS which is collectively applied for the first RU and the second RU.

Such a configuration of using a single interleaver, rather than multiple interleavers, enables an identical MCS to be applied on multiple RUs of a small-size multi-RU. Even though each RU has a different respective number of tones, the interleaver as disclosed herein may help to improve accuracy and efficiency of the permutations of coded bits in a matrix for the multiple RUs. Accordingly, hardware cost may be reduced significantly.

Referring to FIG. 8 again, it is noted that in this example, the modulator 810, acting as a common mapper for the multi-RUs, receives the interleaved sequence I from the interleaver 808, modulates the interleaved sequence I onto a plurality of subcarriers, and outputs the modulated sequence M to the parser 806. In some other examples, multiple modulators 810(1)-(n) (generically referred to as modulator 810) may be respectively placed on each RU processing path after the parser 806. That is, the interleaver 808 sends interleaved sequence I to the parser 806, and then the parser 806 parses the interleaved sequence I into n parallel sequences for the n RUs. Each modulator 810 modulates data bits for each RU to constellation symbols for a plurality of subcarriers. It is noted that placement of the constellation mapper(s) 810 before or after the parser 806 does not have any impact of the generation of output 613.

An example of the operation of the transmitter 800 of FIG. 8 can be summarized as follows: an input data stream 602 of source data bits is received that includes multiple sequences of data bits for transmission to a target station that has been assigned multiple resource units RU1 to RU n. Encoding and modulating (e.g., BCC encoder 804 and modulator 810) is applied to the multiple sequences of data bits to generate a stream of respective modulated sequences M, the modulated sequences being coded and modulated using the same modulation and coding scheme and comprising a set of constellation symbols for a set of subcarriers. The stream of modulated sequences M is parsed (e.g. constellation symbol parser 806) to parse the constellation symbols to respective resource units (e.g., RU 1 to RU n) corresponding to an OFDM symbol.

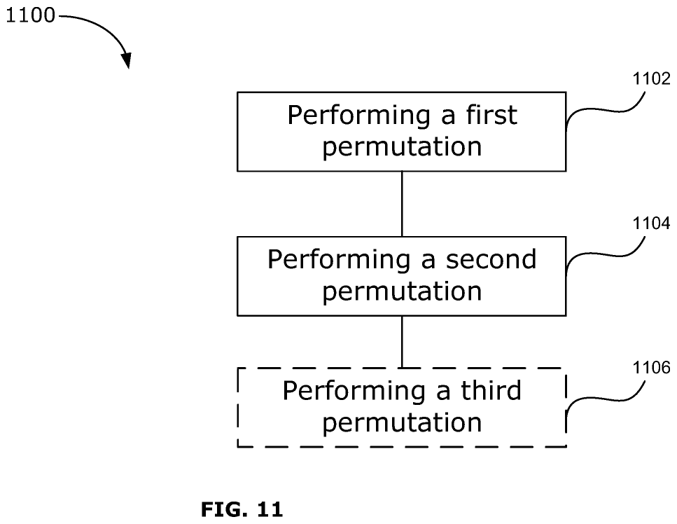

FIG. 11 shows a flow chart of a method 1100 implemented by an interleaver, for example the interleaver 808 as discussed above, in accordance with example embodiments. The method 1100 includes:

At step 1102: a first permutation is performed. The interleaver 808 writes a sequence of coded bits in rows of a matrix. The number of rows, N_{ROW}, is discussed with reference to the equation (9) above. In some examples, the first permutation causes adjacent coded bits to be mapped onto nonadjacent subcarriers.

At step 1104: a second permutation is performed. The interleaver 808 then performs the second permutation by reading the coded bits stored in the matrix out by columns of the matrix. The number of columns, N_{COL}, is illustrated above as well. In some examples, the second permutation causes adjacent coded bits to be mapped alternately onto less and more significant bits of the constellation, which may help to avoid long runs of low reliability (LSB).

Optionally, at step 1106: a third permutation is performed. The interleaver 808 then applies a frequency rotation to the output of the second permutation, such as the equation (5) disclosed above.

At a STA, acting as a receiver, data transmitted from any of transmitters 600-800 disclosed above can be recovered by applying a process that is largely the inverse of that done at the transmitter 600, 700 or 800 an AP-STA 504. For example, a receiving STA 502 can demodulate and decode the PHY header of a received PPDU to determine what RUs have been assigned to that STA 502 and the MCS used for the RUs. The STA 502 can then demodulate the signals on the subcarrier sets belonging to the multiple RUs assigned to that STA 502 based on the modulation type indicated in the recovered MCS information. The demodulated RU signals can each then be decoded to recover the coded words based on the code rate indicated in the recovered MCS.

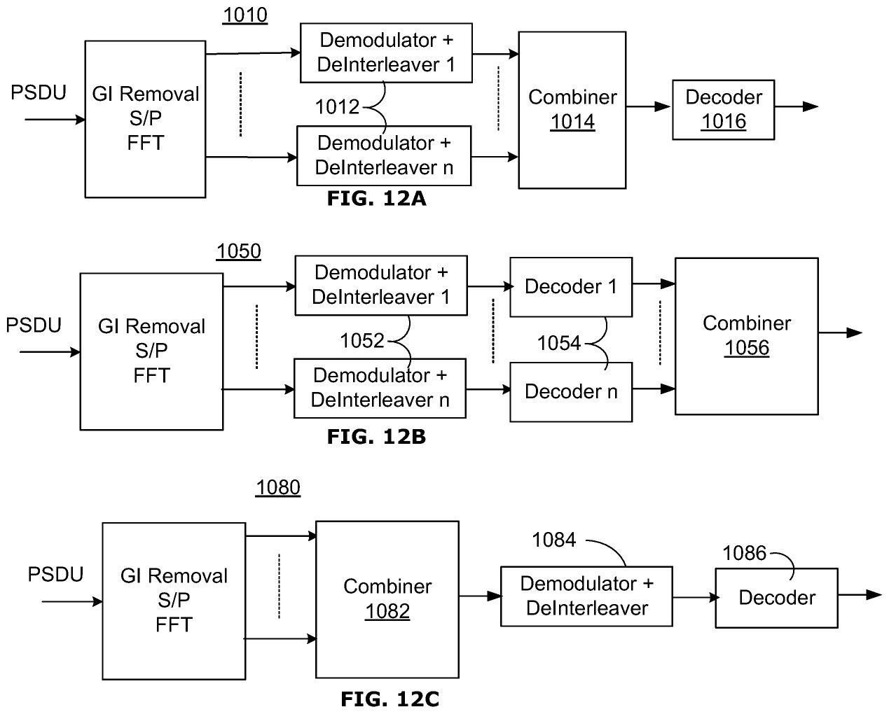

FIG. 12A illustrates selected components of a receiver 1010 that may be used to recover data from the data portion of a PPDU transmitted by transmitter such as transmitter 600. Receiver 1010 includes a combiner 1014 (e.g., de-parser) to combine recovered bits from a set of n de-modulating and de-interleaving streams 1012 into a single stream of received codewords for processing by decoder 1016. FIG. 12B illustrates selected components of a receiver 1050 that may be used to recover data from the data portion of a PPDU transmitted by transmitter such as transmitter 700. Receiver 1050 includes a combiner 1056 (e.g., de-parser) to combine recovered bits from a set of n de-modulating and de-interleaving and decoding streams 1052, 1054 into a single stream of recovered data. FIG. 12C illustrates selected components of a receiver 1080 that may be used to recover data from the data portion of a PPDU transmitted by transmitter such as transmitter 800. Receiver 1050 includes a combiner 1082 to information from an FFT that is then provided to a single de-modulating, interleaving and decoding stream 1084, 1086.

In the case of transmitter 800, the corresponding receiver 1080 may include a deinterleaver to perform deinterleaving by implementing the inverse permutation. A first operation reverses the third permutation (frequency rotation) of the interleaver 808. The output of the first operation is defined by following equation (10).

j=(r+J(iₛₛ)N_{ROT}(2N_{BPSC0}+N_{BPSC1}))mod N_{CBPS},r=0,1, . . . ,N_{CBPS}−1 (10)

Where symbols r, iₛₛ, N_{ROT}, N_{BPSC0}, N_{BPSC1}, N_{CBPS}, and J(iₛₛ) are identical to those discussed above in the example of the interleaver 808.

A second operation defined by following equation (11) reverses the second permutation in the interleaver.

$$i = s ⌊ \frac{j}{s} ⌋ + ( j + ⌊ \frac{j \cdot {N}_{COL}}{{N}_{CBPS}} ⌋ ) mod s , \\ j = 0 , 1 , … , {N}_{CBPS} - 1 \qquad ( 11 )$$

Where symbols s, N_{COL}, and N_{CBPS} are identical to those discussed above in the example of the interleaver 808.

The third operation, as defined in following equation (12), reverses the first permutation of the interleaver 808.

$$k = {N}_{COL} \cdot i - ( {N}_{CBPS} - 1 ) ⌊ \frac{i}{{N}_{ROW}} ⌋ , \\ i = 0 , 1 , … , {N}_{CBPS} - 1 \qquad ( 12 )$$

Where symbols N_{COL}, N_{ROW}, and N_{CBPS} are identical to those discussed above in the example of the interleaver 808.

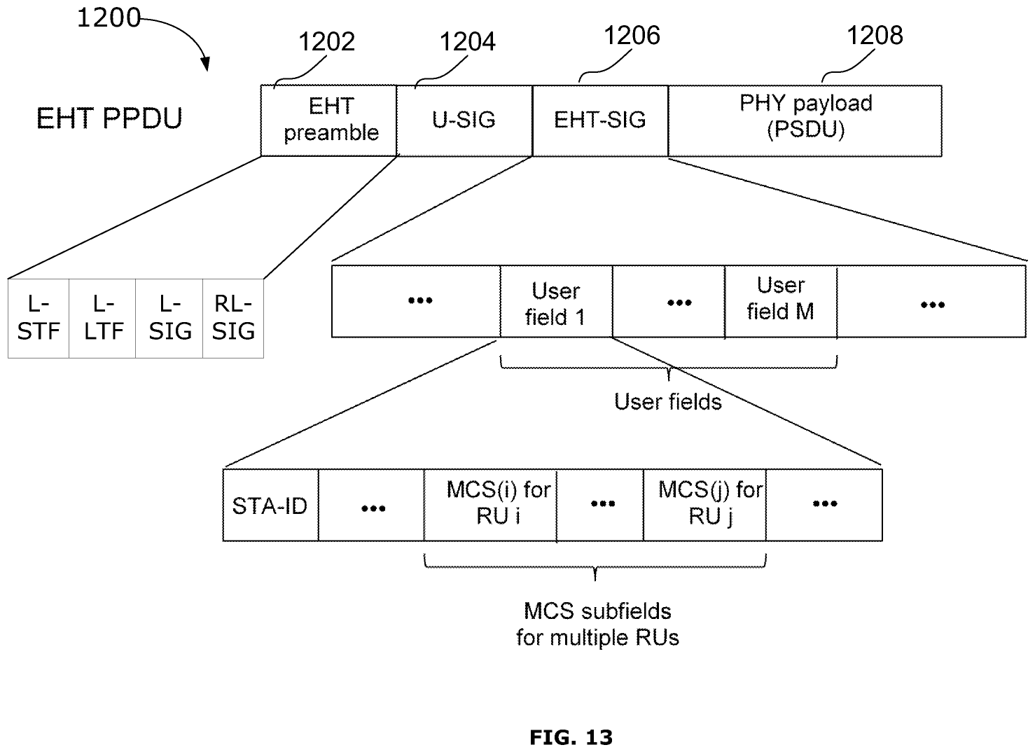

FIG. 13 illustrates an example frame format 1200 that may be used for an EHT PPDU according to example embodiments. The output 530 generated from any of the transmitters 600, 700, or 800 is included in PSDU 1208, which is appended to a PHY header to provide a PPDU that is modulated onto a carrier frequency and transmitted through wireless medium 506. In this regard, the PHY header appended to the PSDU may include the following header fields: EHT preamble 1202, Universal Signal Field (U-SIG) 1204, and EHT Signal Field (EHT-SIG) 1206. The EHT preamble 1202 includes Legacy Short Training Field (L-STF), Legacy Long Training Field (L-LTF), Legacy Signal Field (L-SIG), and Repeated L-SIG (RL-SIG). In example embodiments, information about the RUs assigned to a STA, such as the RU location and the RU size, and the MCS selected for the data bits per OFDM symbol transmitted over the assigned RU, can be indicated in the EHT-SIG field of the PPDU. For example, the EHT-SIG field 1206 may include subfields for each STA 502 (e.g. User field 1 to User field M). Each user field can include subfields that specify: STA-ID that uniquely identifies the target STA, the RUs assigned to the target STA, and the MCSs used for each of the respective RUs assigned to the target STA (e.g., MCS(i) for RU i; MCS(j) for RU j). In example embodiments, the MCS subfields can be populated with an MCS index value that maps to the specified MCS applied to the RU. As shown in FIG. 2 of the MCS indexes, there are 10 MCS types, such as MCS 0 to MCS 9. For 2 RUs are combined to form a small-size multi-RU, there may be 100 possible combinations, and 7 bits may be used to indicate MCS type. In some examples, when the number of combination of RUs to form a small-size multi-RU, the number of bits used to indicate MCS indexes/types may be reduced. In the case where more than 2 RUs are combined to be assigned to a STA, more than 7 bits may be needed to indicate the MCS indexes for each RU. In some examples, a table may be defined to indicate how many bits are needed to indicate each MCS which is scheduled with a different respective RU in the case where the multi-RU includes more than two RUs.

In some other examples, in the case where more than two RUs are combined to assign to a STA, a base RU is selected among the more than two RUs, and a MCS scheduled for the base RU may be indicated in the EHT-SIG 1206. MCS differences between other RUs of the more than 2 RUs and the base RU may be indicated in the EHT-SIG 1206 with less bit occupation, in accordance with example embodiments. In some examples, the base RU may be a left most RU of the combination of the more than 2 RUs. In some examples, 3 RUs (e.g., a first RU, a second RU, and a third RU) are combined to assigned to the STA for OFDMA transmission, if a MCS for a base RU (e.g., the first RU) is MCS 7, and MCS 5 and MCS 4 for the rest of two RUs (e.g., the second and third RUs), the first 4 bits are used to indicate the based RU (the first RU) is scheduled with MCS 7. Therefore, the remainder 3 bits within the 7 bits will be used to indicate a first difference between the base RU and the second RU by using a MCS step, and a second difference between the base RU and the third RU by using a second MCS step. In the remainder 3 bits, the first bit may indicate that whether each of the first and second difference is in a positive direction or in a negative direction. The rest two bits of the remainder 3 bit may use a respective step (e.g., maximum 4 steps) to indicate the first and second differences. For example, in the case where MCS 7 is indicated in first 4 bits of the 7 bits to be scheduled with the base RU, the last two bits of the 7 bits can indicate MCS 3 (7−3=4 reaches the maximum 4 steps) in a negative direction and indicate MCS 9 (9−7=2, MCS9 reaches the last MCS type as shown in FIG. 2). In some examples, the number of RUs in a multi-RU scheduling may be indicated in the multi-RU allocation, such as indicated in EHT-SIG 1206.

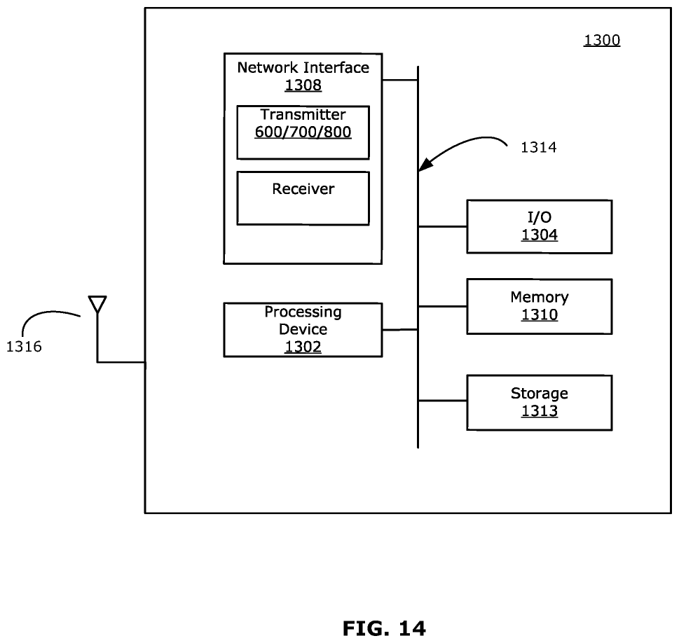

FIG. 14 illustrates an example processing system 1300, which may be used to implement methods and systems described herein, such as the STA 502 or the AP-STA 504. Other processing systems suitable for implementing the methods and systems described in the present disclosure may be used, which may include components different from those discussed below. Although FIG. 14 shows a single instance of each component, there may be multiple instances of each component in the processing system 1300.

The processing system 1300 may include one or more processing devices 1302, such as a processor, a microprocessor, an application-specific integrated circuit (ASIC), a field-programmable gate array (FPGA), a dedicated logic circuitry, or combinations thereof. The processing system 1300 may also include one or more input/output (I/O) interfaces 1314, which may enable interfacing with one or more appropriate input devices and/or output devices (not shown). One or more of the input devices and/or output devices may be included as a component of the processing system 1300 or may be external to the processing system 1300. The processing system 1300 may include one or more network interfaces 1308 for wired or wireless communication with a network. In example embodiments, network interfaces 1308 include one or more wireless interfaces such as transmitters 600, 700, or 800 that enable communications in a WLAN such as network 500. The network interface(s) 1308 may include interfaces for wired links (e.g., Ethernet cable) and/or wireless links (e.g., one or more radio frequency links) for intra-network and/or inter-network communications. The network interface(s) 1308 may provide wireless communication via one or more transmitters or transmitting antennas, one or more receivers or receiving antennas, and various signal processing hardware and software, for example. In this regard, some network interface(s) 1308 may include respective processing systems that are similar to processing system 1300. In this example, a single antenna 1316 is shown, which may serve as both transmitting and receiving antenna. However, in other examples there may be separate antennas for transmitting and receiving. The network interface(s) 1308 may be configured for sending and receiving data to the backhaul network 510 or to other STAs, user devices, access points, reception points, transmission points, network nodes, gateways or relays (not shown) in the network 500.

The processing system 1300 may also include one or more storage units 1313, which may include a mass storage unit such as a solid state drive, a hard disk drive, a magnetic disk drive and/or an optical disk drive. The processing system 1300 may include one or more memories 1310, which may include a volatile or non-volatile memory (e.g., a flash memory, a random access memory (RAM), and/or a read-only memory (ROM)). The non-transitory memory(ies) 1310 may store instructions for execution by the processing device(s) 1302, such as to carry out the present disclosure. The memory(ies) 1310 may include other software instructions, such as for implementing an operating system and other applications/functions. In some examples, one or more data sets and/or module(s) may be provided by an external memory (e.g., an external drive in wired or wireless communication with the processing system 1300) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 1314 providing communication among components of the processing system 1300, including the processing device(s) 1302, I/O interface(s) 1304, network interface(s) 1308, storage unit(s) 1313, memory(ies) 1310. The bus 1314 may be any suitable bus architecture including, for example, a memory bus, a peripheral bus or a video bus.

The present disclosure provides certain example algorithms and calculations for implementing examples of the disclosed methods and systems. However, the present disclosure is not bound by any particular algorithm or calculation. Although the present disclosure describes methods and processes with steps in a certain order, one or more steps of the methods and processes may be omitted or altered as appropriate. One or more steps may take place in an order other than that in which they are described, as appropriate.

Through the descriptions of the preceding embodiments, the present invention may be implemented by using hardware only, or by using software and a necessary universal hardware platform, or by a combination of hardware and software. Based on such understandings, the technical solution of the present invention may be embodied in the form of a software product. The software product may be stored in a non-volatile or non-transitory storage medium, which can be a compact disk read-only memory (CD-ROM), USB flash drive, or a hard disk. The software product includes a number of instructions that enable a computer device (personal computer, server, or network device) to execute the methods provided in the embodiments of the present invention.

Although the present invention and its advantages have been described in detail, it should be understood that various changes, substitutions and alterations can be made herein without departing from the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of processing data for transmission in an Orthogonal Frequency-Division Multiple Access (OFDMA) wireless network, comprising:
encoding an input data stream of source data bits using a first coding rate to generate a data stream of multiple sets of coded bits for a target station that has been assigned multiple resource units, each set of coded bits corresponding to a respective one of the resource units;
puncturing each of the multiple sets of coded bits in the data stream using a respective puncturing pattern to generate respective punctured coded data bits sequences that each correspond to a respective coding rate, wherein at least some of the respective puncturing patterns are different; and
modulating each of the punctured coded data bits sequences using respective modulation types to generate respective modulated code sequences that are each mapped to a respective set of subcarriers that correspond to a respective resource unit of the multiple resource units.

2. The method of claim 1 comprising:
selecting the respective coding rates and the respective modulation types based on channel conditions in the wireless network for the respective sets of subcarriers that correspond to the multiple resource units, enabling different coding rates and modulation types to be applied to the sets of coded bits that correspond to different resource units.

3. The method of claim 1 wherein the respective coding rates and respective modulation types are specified by predefined modulation and coding schemes (MCSs), wherein a different MCS is used for one of the sets of coded bits corresponding to a respective resource unit than for one or more other sets of the coded bits.

4. The method of claim 3 wherein the respective sets of subcarriers are non-contiguous with each other.

5. The method of claim 1 wherein each set of subcarriers that corresponds to a respective resource unit comprises up to a total of 242 contiguous subcarriers.

6. The method of claim 5 wherein the at least one of the sets of subcarriers includes a different number of subcarriers than one or more other sets of the subcarriers.

7. The method of claim 5 wherein the sets of subcarriers all fall within a 20 MHz channel.

8. The method of claim 1 wherein:
encoding the input data stream comprises, for each set of coded bits, applying rate ½ binary convolution coding by applying a first generator polynomial and a second generator polynomial to a respective sequence of bits in the input data stream the generate the set of coded bits;
the method further comprising:
parsing a stream that includes the punctured coded data bits sequences into separate streams that each include a respective one of the punctured coded data bits sequences that are each provided to a respective modulation operation for the modulating; and
transmitting, in the wireless network, an orthogonal frequency division multiplexing (OFDM) symbol including the modulated code sequences.

9. A transmit station for transmitting data in an Orthogonal Frequency-Division Multiple Access (OFDMA) wireless local area network (WLAN), comprising:
a network interface configured to send and receive signals in the WLAN;
a processing device coupled to the network interface;
a non-transitory storage coupled to the processing device and storing thereon instructions that, when executed by the processing device, configure the transmit station to:
encode an input data stream of source data bits using a first coding rate to generate a data stream of multiple sets of coded bits for a target station that has been assigned multiple resource units, each set of coded bits corresponding to a respective one of the resource units;
puncture each of the multiple sets of coded bits in the data stream using a respective puncturing pattern to generate respective punctured coded data bits sequences that each correspond to a respective coding rate, wherein at least some of the respective puncturing patterns are different;
modulate each of the punctured coded data bits sequences using respective modulation types to generate respective modulated code sequences that are each mapped to a respective set of subcarriers that correspond to a respective resource unit of the multiple resource units.

10. The transmit station of claim 9 wherein the transmit station is configured to select the respective coding rates and the respective modulation types based on a channel conditions in the wireless network for the respective sets of subcarriers that correspond to the multiple resource units, enabling different coding rates and modulation types to be applied to the sets of coded bits that correspond to different resource units.

11. A method of processing data for transmission in an Orthogonal Frequency-Division Multiple Access (OFDMA) wireless network, comprising:
parsing an input data stream to generate multiple sequences of source data bits for a target station that has been assigned multiple resource units, each sequence of source data bits corresponding to a respective one of the resource units;
encoding each sequence of source data bits of the multiple sequences of source data bits based on a respective coding rate to generate respective coded data bits sequences;
modulating each of the coded data bits sequences using respective modulation types to generate respective modulated code sequences that are each mapped to a respective set of subcarriers that correspond to a respective resource unit of the multiple resource units.

12. The method of claim 11 comprising:
selecting the respective coding rates and the respective modulation types based on a channel conditions in the wireless network for the respective sets of subcarriers that correspond to the multiple resource units, enabling different coding rates and modulation types to be applied to the sequences of source data bits that correspond to different resource units.

13. The method of claim 12 wherein the respective coding rates and respective modulation types are specified by predefined modulation and coding schemes (MCSs), wherein a different MCS is used for one of the sequences of source data bits corresponding to a respective resource unit than for one or more other sequences of source data bits.

14. The method of claim 13 wherein the respective sets of subcarriers are non-contiguous with each other.

15. The method of claim 11 wherein each set of subcarriers that corresponds to a respective resource unit comprises up to a total of 242 contiguous subcarriers.

16. The method of claim 15 wherein the at least one of the sets of subcarriers includes a different number of subcarriers than one or more other sets of the subcarriers.

17. The method of claim 15 wherein the sets of subcarriers all fall within a 20 MHz channel.

18. The method of claim 11 comprising interleaving each of the respective coded data bits sequences prior to modulating the respective coded data bits sequences.

19. A transmit station for transmitting data in an Orthogonal Frequency-Division Multiple Access (OFDMA) wireless local area network (WLAN), comprising:
a network interface configured to send and receive signals in the WLAN;
a processing device coupled to the network interface;
a non-transitory storage coupled to the processing device and storing thereon instructions that, when executed by the processing device, configure the transmit station to:
parse an input data stream to generate multiple sequences of source data bits for a target station that has been assigned multiple resource units, each sequence of source data bits corresponding to a respective one of the resource units;
encode each sequence of source data bits of the multiple sequences of source data bits based on a respective coding rate to generate respective coded data bits sequences; and
modulate each of the coded data bits sequences using respective modulation types to generate respective modulated code sequences that are each mapped to a respective set of subcarriers that correspond to a respective resource unit of the multiple resource units.

20. The transmit station of claim 19 wherein the transmit station is configured to select the respective coding rates and the respective modulation types based on a channel conditions in the wireless network for the respective sets of subcarriers that correspond to the multiple resource units, enabling different coding rates and modulation types to be applied to the sequences of source data bits that correspond to different resource units.

21. A method of processing data for transmission in an Orthogonal Frequency-Division Multiple Access (OFDMA) wireless network, comprising:
receiving an input data stream of source data bits that includes multiple sequences of data bits for transmission to a target station that has been assigned multiple resource units;
encoding and modulating the multiple sequences of data bits to generate a stream of modulated sequences, the modulated sequences being coded and modulated using the same modulation and coding scheme and comprising a set of constellation symbols for a set of subcarriers; and
parsing the stream of modulated sequences to parse the constellation symbols to respective resource units corresponding to an OFDM symbol.
